(19) United States
(12) Patent Application Publication
(10) Pub. No.: US 2010/0274632 A1
(43) Pub. Date: Oct. 28, 2010

(54) CUSTOMER SATISFACTION MONITORING SYSTEM

(75) Inventor: Marina Jane Pullin, South Australia (AU)

Correspondence Address: GREENBLUM & BERNSTEIN, P.L.C., 1950 ROLAND CLARKE PLACE, RESTON, VA, 20191, US

(73) Assignee: RADFORD INSTITUTE AUSTRALIA PTY LTD, South Australia (AU)

(21) Appl. No.: 12/676,040

(22) PCT Filed: Sep. 4, 2008
(86) PCT No.: PCT/AU2008/001317

§ 371 Date: Jun. 29, 2010

(30) Foreign Application Priority Data
Sep. 4, 2007 (AU) 2007-904796

(51) Int. Cl. G06Q 10/00; G06F 3/048

(52) U.S. Cl. 705/10; 705/347; 715/764

(57) ABSTRACT

A monitoring system for monitoring user assessment information at a predetermined location in real time is disclosed. The system includes user input means positioned at the location to capture the user assessment information and data storage means to store the user assessment information where the user assessment information also includes time and location information identifying the time and location of the capturing of the user assessment information. The system further includes data processing means to process the user assessment information in combination with other related user assessment information captured at different times to generate summary information.

### CLAIM OF PRIORITY

The present application for patent claims priority from Australian Provisional Patent Application No. 2007904796 entitled “CUSTOMER SATISFACTION MONITORING SYSTEM”, filed 4 Sep. 2007, which is hereby expressly incorporated by reference herein in its entirety.

### TECHNICAL FIELD

The present invention relates to a monitoring system for the gathering and processing of information. In a particular form, the present invention relates to a monitoring system for the gathering and processing of customer satisfaction information.

### BACKGROUND

As is well understood by marketing and business professionals, there are a number of factors which feed into a customer's satisfaction with any given product or service. Clearly, one factor is the inherent quality of the goods and/or services themselves. Another important consideration is the “shopping experience” that a customer experiences. This can be dependent on a number of factors ranging from the level and quality of service provided by personnel who are “selling” the goods and/or services to a potential customer to the ambience and general feel of a retail outlet.

One method of attempting to determine customer satisfaction is by the use of market surveys. These are typically conducted by marketing professionals who through the use of questionnaires and interviews will attempt to determine what the most important factors that went into any purchasing decision were. These surveys are typically conducted using “mystery shoppers” or focus groups which are made up of likely customers for the goods and/or services that are of interest. However, there are a number of significant disadvantages with the use of focus groups. The primary disadvantage is that they are remote temporally and physically from the actual shopping or retail experience that is being studied. Whilst a particular product and/or service may be judged to be appealing in the context of a focus group, often these results are not replicated outside of this artificial environment.

Another significant problem with the use of focus groups is that their results are necessarily biased by a selection effect due to the fact that only a limited number of people are surveyed and therefore their opinions cannot be extended to the general population of customers for particular goods or services. Another problem is that they are expensive to conduct.

One attempt to overcome the disadvantages of the use of focus groups and the like is to employ a “feedback” or “suggestion” box where customers are encouraged to voice their opinions. Whilst the information provided by a feedback or suggestion box is more closely related to the actual shopping experience, this method of obtaining customer satisfaction information will invariably only capture the opinions of those who are either strongly satisfied or dissatisfied due to the amount of time and effort required to express an opinion. There is therefore a need in the art for a monitoring system capable of conveniently collecting customer satisfaction information as part of the shopping or retail experience and which can be employed for the real time benchmarking of customer satisfaction.

### SUMMARY

In a first aspect the present invention accordingly provides a monitoring system for monitoring user assessment information at a predetermined location in real time, the system including:
user input means positioned at the location to capture the user assessment information;
data storage means to store the user assessment information, the user assessment information also including time and location information identifying the time and location of the capturing of the user assessment information; and
data processing means to process the user assessment information in combination with other related user assessment information captured at different times to generate summary information.

In another form, the user assessment information is monitored at a plurality of locations in real time, the system further including:
additional user input means corresponding to the plurality of locations to capture corresponding user assessment information, wherein the data storage means is further operable to store each of the corresponding user assessment information, each corresponding user assessment information also including time and location information identifying the time and location of the capturing of the corresponding user assessment information and wherein the data processing means is further operable to process the user assessment information with the corresponding user assessment information captured at different times and locations to generate summary information.

In another form, the plurality of locations are located at a site for the provision of goods and/or services and the user assessment information is customer satisfaction data related to the provision of goods and/or services.

In another form, one or more of the plurality of locations are located at different sites for the provision of the goods and/or services.

In another form, the different sites relate to different providers or suppliers of the goods and/or services.

In another form, the summary information includes benchmarking information related to customer satisfaction data compared at different sites.

In another form, the summary information includes benchmarking information related to customer satisfaction data compared from different providers.

In another form, the system further includes a user interface to display the summary information.

In another form, the user interface allows a user to configure the monitoring system.

In another form, the user input means is a stand alone user input module.

In another form, the user input module displays a question.

In another form, the user input module includes a plurality of discrete assessment indicators to capture the user assessment information related to the question.

In another form, the user input module includes variable range input means to capture the user assessment information related to the question.

In another form, the user input module includes a wireless transmission device to transmit user assessment information to the data storage means.

Alternatively, the user input means is a personal mobile device.

In a second aspect the present invention accordingly provides a method for monitoring user assessment information from a predetermined location in real time, the method including:
capturing user assessment information, the user assessment information including the time and location of the capturing; and
processing the user assessment information in combination with related user assessment information captured at a different time.

In another form, method further includes:
capturing corresponding user assessment information at a plurality of locations, each corresponding user assessment information including the time and location of capturing at the respective location; and
processing the user assessment information with the corresponding user assessment information captured at different times and locations to generate summary information.

In a second aspect the present invention accordingly provides a benchmarking system including:
a plurality of user input means located at a plurality of providers of related goods and/or services, wherein the user input means capture customer satisfaction information related to the provision of the goods and/or services;
data processing means to process the customer satisfaction information from the plurality of user input means to generate benchmarking information comparing the different providers in real time.

In another form, the customer satisfaction information includes the time and location of the captured customer satisfaction information corresponding to each user input means.

In another form, the user input means include personal mobile devices.

### BRIEF DESCRIPTION OF THE DRAWINGS

Embodiments of the present invention will be discussed with reference to the accompanying drawings wherein:

FIG. 1 is a system diagram of a monitoring system according to a first illustrative embodiment of the present invention;

FIG. 2 is a front view of a first example stand alone user input module for capturing customer satisfaction information;

FIG. 3 is a front view of a second example stand alone user input module for capturing customer satisfaction information; and

FIG. 4 is a system diagram of a monitoring system according to a second illustrative embodiment of the present invention.

In the following description, like reference characters designate like or corresponding parts throughout the several views of the drawings.

### DETAILED DESCRIPTION

The following description contains specific information pertaining to the implementation of the present invention. One skilled in the art will recognise that the present invention may be implemented in a manner different from that specifically discussed in the present application. Moreover, some of the specific details of the invention are not discussed in order not to obscure the invention. The specific details not described in the present application are within the knowledge of a person of ordinary skill in the art.

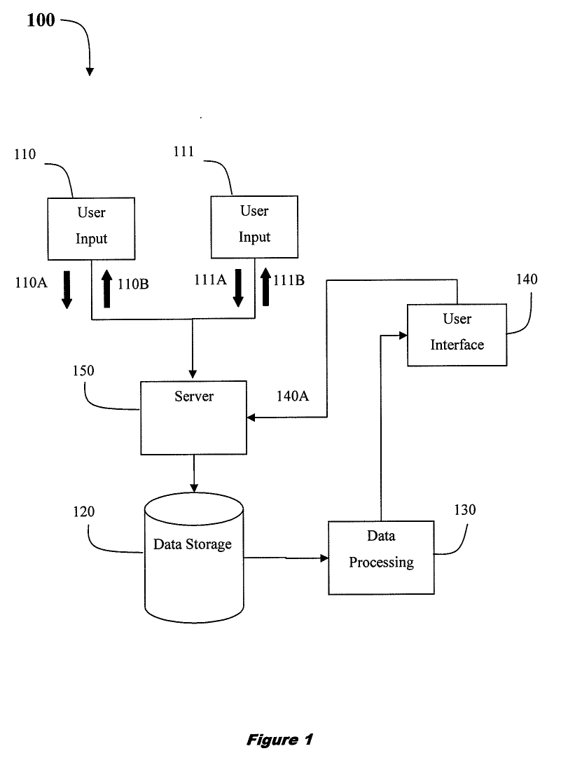

Referring now to FIG. 1, there is shown a system diagram of a monitoring system 100 for monitoring user assessment information at a predetermined location in real time in accordance with a first illustrative embodiment of the invention. In this illustrative embodiment, monitoring system 100 is adapted to capture customer satisfaction data or information with respect to the provision of goods and/or services. However, as would be appreciated by those skilled in the art, the present invention may be applied generally to the collection of user assessment information from a predetermined location in real time.

Monitoring system 100 includes two user input modules 110, 111, intermediate server 150, data storage means 120, data processing means 130 and user interface 140 for the display of summary data and also for customisation or configuration of the monitoring system 100.

In one example, user input modules 110, 111 may be located at separate checkout aisles in a supermarket or locations in a department store. Alternatively, the user input modules 110, 111 could be located in similar locations at different sites owned by the same provider of goods and/or services. An example of this type of deployment would be the provision of a single user input module at a number of bank branches within a banking network. As would be apparent to those skilled in the art, the number of deployed input modules will vary according to the number of physical locations where data is being sought to be gathered and in one illustrative embodiment the monitoring system may include only a single user input module.

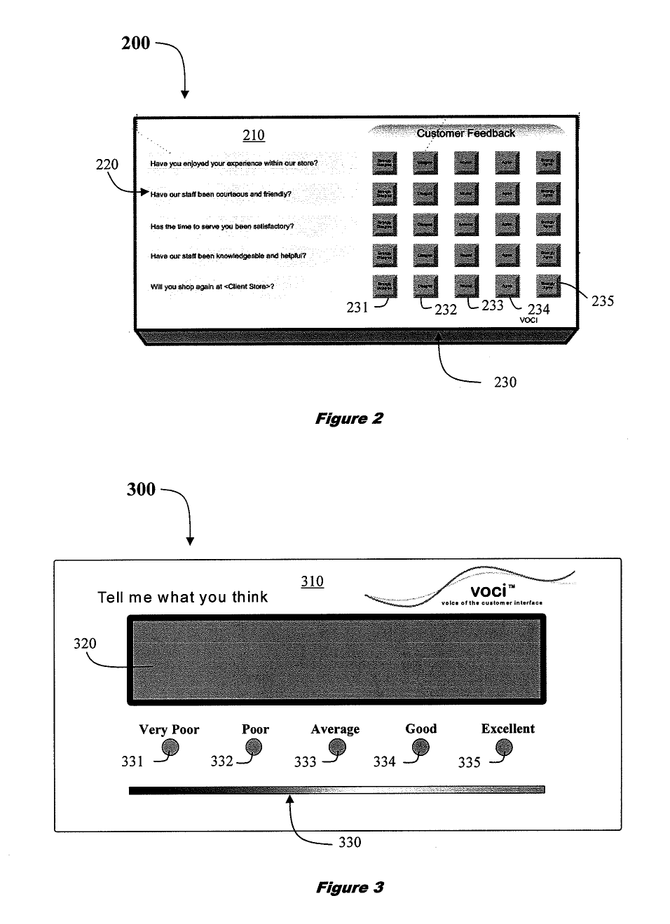

Referring now to FIG. 2, there is shown a first example stand alone user input module 200 which may be deployed as user input modules 110, 111 as shown in FIG. 1. User input module 200 consists of a front panel 210 that includes one or more survey questions 220 and then a number of discrete assessment indicators 230 that relate to the survey questions 220 ranging from “STRONLY DISAGREE” 231, “DISAGREE” 232, “NEUTRAL” 233, “AGREE” 234, “STRONGLY AGREE” 235.

Whilst in this example, user input module 200 incorporates discrete assessment indicators 230, it will be appreciated by those skilled in the art that any type of user input means is contemplated to be within the scope of the invention. For example, a survey question may be posed and a variable range input means such as a slide or rotatable knob be provided which allows a customer to register their assessment on a continuous scale between predetermined end points such as 1 to 100 or 1 to 10. Such a variable range input means may incorporate a graphical display for presenting the exact value entered by a customer. Equally, the user input module may consist of a combination of discrete assessment indicators and variable range input means depending on the survey questions being posed to the customer.

Referring now to FIG. 3, there is shown a second example stand alone user input module 300 which again may be deployed as user input modules 110, 111 as shown in FIG. 1. Similar to user input module 200 depicted in FIG. 2, user input module 300 functions to display a series of survey questions, capture the responses and transmit the data to database or data storage means 120 for further processing by data processing means 130.

In this illustrative embodiment, user input module 300 is deployed as a stand alone module and consists of a housing having dimensions of 220 mm wide, 110 mm deep and 45 mm high. User input module 300 is constructed from Acrylonitrile Butadiene Styrene (ABS) plastic and incorporates non-slip feet to prevent movement while in use. User input module 300 is designed so that it can be operated from an external “plug-pack” to allow worldwide application with the nominal rated power supply input being 7.5V DC at 300 mA. User input module 300 is also fitted with a security tether to prevent theft.

User input module 300 incorporates a front panel 310 having an updatable display 320 where a survey question may be dynamically uploaded. In this example, updatable display 320 consists of a 160-character (4 lines of 40 characters) backlit alphanumeric Liquid Crystal Display (LCD) having a character size of 5 mm, these characters being shown in white on a black background. Updatable display 320 allows the survey questions to be conveniently modified as will be described later. As would be appreciated by those skilled in the art, front panel 310 may consist of a number of updatable displays 320 having associated discrete assessment indicators 330.

User input module 300 also includes a number of discrete assessment indicators 330 that relate to the survey question depicted in updatable display 320 ranging from “VERY POOR” 331, “POOR” 332, “NEUTRAL” 333, “GOOD” 334, “EXCELLENT” 335. Discrete assessment indicators 330 are implemented as momentary push-button switches mounted internally such that they can be operated by pressing on the symbols printed on the front panel 310 overlay. These buttons provide tactile feedback and user input module 300 includes an internal beeper which provides audible confirmation of operation.

User input module 300 includes a pre-programmed microprocessor that provides for device interface and control and further includes its own non-volatile on-board memory, data transmission means, a real time clock with battery backup and noise suppression for preventing interference between electronic devices. The microprocessor further includes an interface to the front panel push-buttons or discrete assessment indicators 230 and an interface to the updatable display or LCD 320. The on-board memory is capable of storing 1,000 individual records. Each record is defined to be 16 bytes long and consists of a date and time stamp (8 bytes), plus up to 8 survey question responses where each response is a number from 1 to 5.

In this example, the data transmission means consists of a wireless transmission device consisting of a Global System for Mobile Communications (GSM) module and an accompanying antenna and associated Subscriber Identity Module (SIM) card slot. The transmission utilises the General Packet Radio Service (GPRS) standard, thereby providing a packet based service for the transmission of data to intermediate server 150. This allows for the provision of secure and encrypted communications based on forming a virtual private network (VPN) over public infrastructure such as a mobile phone system.

As would be appreciated by those skilled in the art, data may be transmitted to and from user input module 300 by any number of network protocols such as TCP/IP implemented over either a direct physical connection such as including but not limited to ethernet, serial (e.g. Universal Serial Bus (USB)) or parallel cabling or alternatively, or in combination with, wireless communications such as infrared (IR), WIFI, Bluetooth™ or mobile phone based systems such as described previously. In this example each input module 300 has a unique IP or MAC address which has a 1 to 1 association with the location of the input module 300.

Data stored in the non-volatile on-board memory is transmitted to the intermediate server 150 and hence to data storage means 120 every 15 minutes. This update rate can be varied according to the amount of data expected to be captured. The original data remains in the non-volatile on-board memory and when the memory is full, the oldest data is overwritten. The data is transmitted as a comma separated value (CSV) packet consisting of a unique location ID, date and time stamp and the set of 5 responses. Only complete valid records are stored and sent.

Although stand alone user input modules have been described in the various illustrative embodiments set out herein, it will be clear to those skilled in the art that any user input means is contemplated to be within the scope of the invention. As an example, the user input means may be associated or integrated with a point of sale device such as a credit card or Electronic Fund Transfer at Point Of Sale (EFTPOS) terminal or deployed within a sales kiosk setup or involve a terminal displaying a web page that allows for the capture of user assessment information that can be date and location stamped.

In another illustrative embodiment, the user input means may be a customer's own mobile phone or personal digital assistant (PDA) such as an iPhone™. In this illustrative embodiment, user input software is uploaded to a person's own mobile device that presents a customised user interface that allows a customer to select the location that they are located at.

In one embodiment this is achieved by providing of a location identifier code at the point of sale or other relevant location which uniquely identifies the location and which the customer enters into the user interface. In another embodiment which relates to mobile phones equipped with global positioning satellite (GPS) capability, the customer is provided with a narrow selection of potential locations based on the location of the mobile device as determined by the GPS. One or more survey questions are then presented to the customer and depending on the user interface these may be accompanied by discrete and/or continuous assessment indicators. The customer then enters the feedback information and this information is uploaded via the mobile phone network to intermediate server 150.

Referring once again to FIGS. 1 and 3, in operation monitoring system 100 will include a number of input modules 110, 111 which in this illustrative embodiment is stand alone input module 300. A customer encountering stand alone input module 300 will be presented with a series of survey questions which in a default implementation include:
Q1. How would you rate the product range of our store?
Q2. How would you rate the pricing of our products?
Q3. How would you rate your overall shopping experience today?
Q4. How would you rate the service from our staff today?
Q5. What would you tell your friends about the quality of our store?

Each of these questions will be presented in turn on updatable display 320 and input module 300 will enter into an idle state until a customer activates one of the discrete assessment indicators 330 in line with their response to the question.

Once each of the questions has been answered the user input module 300 will indicate that the survey is completed and read the time and date and store the survey answers to non-volatile memory and be ready to receive further responses.

The stored data is then transferred (e.g. 110A, 111A) to intermediate server 150 which functions to validate and authenticate the data received from the user. In this embodiment, the data is transferred over a VPN by a wireless telecommunication link employing the GPRS protocol as described previously but equally the data may be transferred by other wireless communications means and/or a physical network link as has also been described previously. Following this validation and authentication process, the data is stored in data storage means 120.

In this illustrative embodiment, the intermediate server 150 is shown as a separate entity, however as would be apparent to those skilled in the art, intermediate server may be an application that runs on the same physical machine and is integrated with data storage means 120 or data processing means 130.

Data storage means 120 in this illustrative embodiment is a relational database such as a Structure Query Language (SQL) database as is known in the art and the intermediate server 150 uploads the data to data storage means 120 by a series of SQL calls. Data storage means 120 may be located on site or in a centralised location depending on requirements.

Data processing means 130 functions to process user assessment information as stored in data storage means 120. As with intermediate server 150, data processing means 130 may be a software application that runs on the same physical machine as the data storage means 120 depending on the functional requirements of the system. In this illustrative embodiment, data processing means 120 will access the customer satisfaction information by a series of SQL data queries.

Data processing means 130 then carries out analysis of the customer satisfaction information to generate summary information which is displayed on user interface 140 for the organisation that has implemented a monitoring system in accordance with the present invention. In this illustrative embodiment, this summary information may include an analysis of customer satisfaction at the location of user input module 110 as a function of time involving the combining the user assessment information with related user assessment information captured at different times. This summary information could then be correlated with personnel attending to customers at this location or to the release of new products or services.

This summary information may further include a comparison analysis of corresponding user assessment or customer satisfaction information corresponding to user input module 111 to compare the satisfaction ratings at two different locations that correspond to the locations of user input modules 110, 111. As in a previously discussed example, user input modules 110, 111 may be located at different branches in a banking network, thereby allowing the customer satisfaction to be measured, compared between branches and then displayed in real time.

As would be appreciated by those skilled in the art, the summary information may be analysed in accordance with business rules that are specific to the type of goods and/or services being sold in order to produce customised reports relevant to that business in real time. These reports can then be correlated in real time with other financial data such as sales volumes and profits to provide graphical information to help determine which retailing strategies are more successful. In one embodiment, real time alerts are provided so that immediate attention can be provided in real time to a location where customer satisfaction is significantly lower than the expected.

User interface 140 may also be used to configure and customise monitoring system 100 by uploading configuration information 140A to intermediate server 150 and hence uploaded 110B, 111B to user input modules 110, 111 by the data transmission means connecting user input modules 110, 111 to intermediate server 150. This configuration information may include hardware configuration information or parameterisation information such as updated survey questions which can be instantly updated if required. In this illustrative embodiment, user interface 140 is implemented as a web page which allows for access by any computer having a suitable web browser.

Whilst in this illustrative embodiment a web based architecture has been employed using JAVA™ based methodologies, as would be apparent to those skilled in the art, equally the functionalities described herein may be implemented in a wide range of programming languages and operating systems.

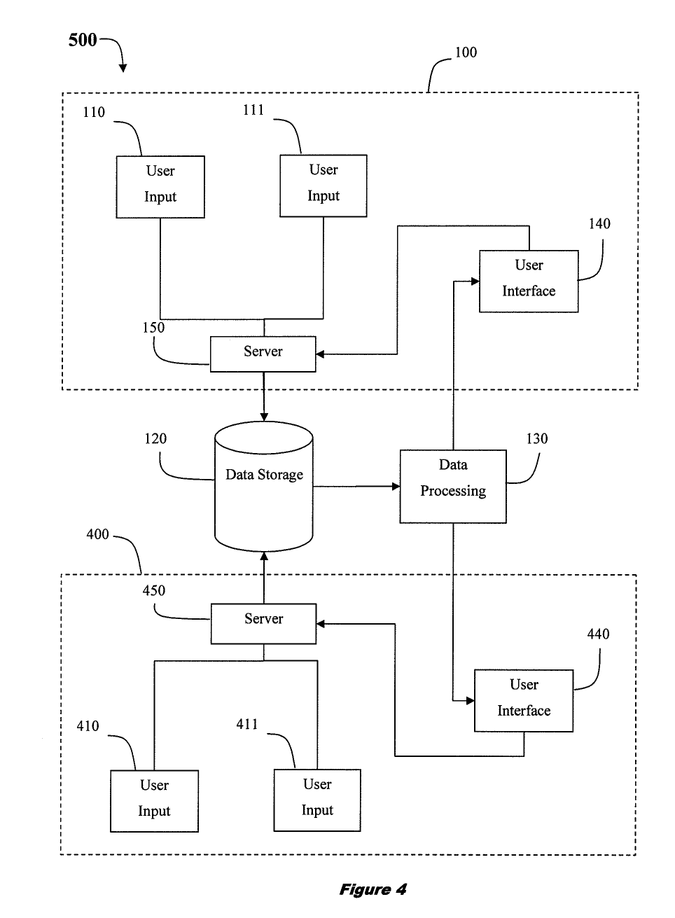

Referring now to FIG. 4, there is shown a system diagram of a monitoring or benchmarking system 500 for monitoring user assessment information in accordance with a second illustrative embodiment of the invention. In this illustrative embodiment, benchmarking system 500 consists of a first monitoring system 100 such has been described previously dedicated to a first supplier or provider of given goods and/or services and a second monitoring system 400 which essentially replicates first monitoring system 100 excepting that it is dedicated to a second supplier or provider of the same or similar goods and/or services.

Second monitoring system 400, in this example includes a further pair of user input modules 410, 411 positioned at different locations as required by the first provider. As has been described previously, user input modules 410, 411 capture customer satisfaction information which is stored in data storage means 120 via intermediate server 450. Once again user interface 440 is employed to both configure and customise monitoring system 400 and display summary information.

Benchmarking system 400 provides a further abstraction of the monitoring process which allows customer satisfaction information to be aggregated from different suppliers of the same or similar goods and/or services. In this manner, industry wide benchmarking can be achieved and users of individual monitoring systems 100, 400 who subscribed to an enhanced or premium service may be provided with real time benchmarking comparison information which compares their customer satisfaction information with that attained by the industry as a whole as well as benchmarking data comparing individual sites within a business.

In another illustrative embodiment, benchmarking system 500 may be used to compare summary information from different industry sectors to contrast the performance of these sectors with respect to the provision of different goods and/or services. This information can then be employed by users of the enhanced or premium service to gain insight into how customer service practices adopted by a different industry sector may be then be adapted for use in their industry sector to improve customer satisfaction and enhance profitability.

As would be appreciated by those skilled in the art, this real time benchmarking information is an essential tool for business to assess how they are performing relative to other providers in the same commercial area and as has been recognised customer satisfaction engenders loyalty which results in increased profits (see for example R. Hallowell, “The Relationships of Customer Satisfaction, Customer Loyalty, and Profitability: an Empirical Study”, International Journal of Service Industry Management, Vol. 7 No. 4, 1996, pp. 27-42, MCB University Press, herein incorporated by reference in its entirety).

A selection of reports that may be generated by the monitoring and benchmarking systems of the present invention is set out below in tabular form.

| Report Name | Report Purpose |
|---|---|
| Analyst | Analyst Reporting allows a user to display organisational |
| Reports | summary information in a customised format. This module is |
| | typically used by a specially trained analyst to provide more |
| | in-depth and bespoke views of data to suit organisational |
| | needs. |
| Establishment | This report highlights the organisation's performance pattern |
| Reports | over a selected time period. The data displayed are against the |
| | selected date range and the view can be drilled down to |
| | departmental level. The report is also able to provide industry |
| | benchmarking information on organisation and departmental |
| | levels. |
| Industry | The Industry Benchmark Report provides the ability to view |
| Benchmark | and compare organisations with the current Industry |
| | Benchmark. It provides means to indicate the organisation's |
| | current standing on Service Satisfaction Level against the |
| | overall Service Satisfaction Level of the industry they are |
| | operating in. |
| Questions | The Questions Report provides the ability to view the |
| Report | performance of all the related survey questions. It highlights |
| | an organisation's performance pattern over the time period |
| | selected by the user. The survey question's data are displayed |
| | against the selected date range and the view can be segregated |
| | if the chosen survey question exists in more than one |
| | Question Set. The Question set can either be non-scheduled or |
| | scheduled. |
| Corporate | The Corporate Results Report provides an overview of |
| Results | satisfaction scores, number of surveys collected, past |
| | performance trends and establishment comparison for the |
| | organisation as a whole. This report is used to quickly |
| | evaluate how the organisation is performing from a customer |
| | satisfaction and monitoring system activity view. |
| Notes Summary | The Notes Summary Report provides a detailed view of |
| Report | recorded activities occurring within the organisation. This |
| | report is employed to compare to, and potentially add context |
| | to satisfaction scores collected in the same period. |
| Demographic | The Demographic Report provides a view of customer |
| Report | satisfaction ratings and past performance trends by area |
| | (National, State and Suburb level) for the organisation, |
| | associated Industry Types and participants in the |
| | benchmarking system. This report is employed to evaluate |
| | customers satisfaction level with the organisation's offering |
| | against others in the same area. |
| Profit | The Finance Report enables a user to view financial results, |
| Report | customer satisfaction ratings and past performance trends for |
| | the organisation and/or its associated establishment(s). This |
| | report is employed to assess the performance of the |
| | organisation from a financial and customer satisfaction view. |

A brief consideration of the present invention readily demonstrates that the monitoring system of the present invention provides a number of distinct advantages over prior art systems. By being able to provide a scaleable system that can be deployed at the point of sale which provides data in real time that can be uniquely related to a location and time, the present system captures customer satisfaction information that is directly related to the retail experience of the customer. By further providing the capability to aggregate this information over different providers, the present invention allows for the provision of real time benchmarking information that allows any one enterprise to compare their ability to supply goods and/or services with other enterprises operating in that area or other areas, thereby providing a unique service which allows business to rapidly react to changing market conditions. In the illustrative embodiments described herein, the data collected by the user input means can be analysed and available online in less than 30 seconds i.e. in real time.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The computer software referred to herein may contain a number of source code or object code segments and may reside in any computer readable medium such as a RAM memory, flash memory, ROM memory, EPROM memory, registers, hard disk, a removable disk, a CD-ROM, a DVD-ROM or any other form of computer readable medium. In the alternative, the computer readable medium may be integral to the processor. The processor and the computer readable medium may reside in an ASIC.

The reference to any prior art in this specification is not, and should not be taken as, an acknowledgement of any form of suggestion that such prior art forms part of the common general knowledge.

Although a preferred embodiment of the method and system of the present invention has been described in the foregoing detailed description, it will be understood that the invention is not limited to the embodiment disclosed, but is capable of numerous rearrangements, modifications and substitutions without departing from the scope of the invention as set forth and defined by the following claims.

1. A monitoring system for monitoring user assessment information at a predetermined location in real time, the system including:
user input means positioned at the location to capture the user assessment information;
data storage means to store the user assessment information, the user assessment information also including time and location information identifying the time and location of the capturing of the user assessment information; and
data processing means to process the user assessment information in combination with other related user assessment information captured at different times to generate summary information.

2. The monitoring system of claim 1, wherein the user assessment information is monitored at a plurality of locations in real time, the system further including:
additional user input means corresponding to the plurality of locations to capture corresponding user assessment information, wherein the data storage means is further operable to store each of the corresponding user assessment information, each corresponding user assessment information also including time and location information identifying the time and location of the capturing of the corresponding user assessment information and wherein the data processing means is further operable to process the user assessment information with the corresponding user assessment information captured at different times and locations to generate summary information.

3. The monitoring system of claim 2, wherein the plurality of locations are located at a site for the provision of goods and/or services and the user assessment information is customer satisfaction data related to the provision of goods and/or services.

4. The monitoring system of claim 3, wherein one or more of the plurality of locations are located at different sites for the provision of the goods and/or services.

5. The monitoring system of claim 4, wherein the different sites relate to different providers or suppliers of the goods and/or services.

6. The monitoring system of claim 4, wherein the summary information includes benchmarking information related to customer satisfaction data compared at different sites.

7. The monitoring system of claim 5, wherein the summary information includes benchmarking information related to customer satisfaction data compared from different providers.

8. The monitoring system of claim 1, wherein the system further includes a user interface to display the summary information.

9. The monitoring system of claim 8, wherein the user interface allows a user to configure the monitoring system.

10. The monitoring system of claim 1, wherein the user input means is a stand alone user input module.

11. The monitoring system of claim 10, wherein the user input module displays a question.

12. The monitoring system of claim 11, wherein the user input module includes a plurality of discrete assessment indicators to capture the user assessment information related to the question.

13. The monitoring system of claims 11, wherein the user input module includes variable range input means to capture the user assessment information related to the question.

14. The monitoring system of claim 10, wherein the user input module includes a wireless transmission device to transmit user assessment information to the data storage means.

15. The monitoring system of claim 1, wherein the user input means is a personal mobile device.

16. A method for monitoring user assessment information from a predetermined location in real time, the method including:
capturing user assessment information, the user assessment information including the time and location of the capturing; and
processing the user assessment information in combination with related user assessment information captured at a different time.

17. The method of monitoring user assessment information of claim 16, further including:
capturing corresponding user assessment information at a plurality of locations, each corresponding user assessment information including the time and location of capturing at the respective location; and
processing the user assessment information with the corresponding user assessment information captured at different times and locations to generate summary information.

18. A benchmarking system including:
a plurality of user input means located at a plurality of providers of related goods and/or services, wherein the user input means capture customer satisfaction information related to the provision of the goods and/or services;
data processing means to process the customer satisfaction information from the plurality of user input means to generate benchmarking information comparing the different providers in real time.

19. The benchmarking system of claim 18, wherein the customer satisfaction information includes the time and location of the captured customer satisfaction information corresponding to each user input means.

20. The benchmarking system of claim 18, wherein the user input means include personal mobile devices.
